(19) United States
(12) Patent Application Publication
(10) Pub. No.: US 2008/0274264 A1
(43) Pub. Date: Nov. 6, 2008

(54) Calcium fortification substance for clear beverages

(76) Inventors: John Godber, Chicago, IL (US); Amr Shaheed, Howell, NJ (US)

Correspondence Address: MCCARTER & ENGLISH LLP;CITYPLACE I, 185 ASYLUM STREET, HARTFORD, CT, 06103, US

(21) Appl. No.: 11/811,199

(22) Filed: Jun. 8, 2007

Related U.S. Application Data
(60) Provisional application No. 60/812,215, filed on Jun. 9, 2006.

(51) Int. Cl. A23L 1/29

(52) U.S. Cl. 426/648

(57) ABSTRACT

Compositions comprising calcium and phosphate which are sufficiently soluble in water to dissolve essentially without any cloudiness in the water are provided. The compositions may be used to provide clear beverages that are fortified in calcium and phosphate. Methods of making the calcium and phosphate compositions are also provided.

### RELATED APPLICATIONS

The present application claims priority under 35 U.S.C. § 119(e) to U.S. Provisional Application No. 60/812,215 filed on Jun. 9, 2006, the entire contents of which are hereby incorporated by reference.

### FIELD OF THE INVENTION

In one aspect, the present invention is directed to a composition comprising calcium and phosphate which is sufficiently soluble in water that it dissolves without any cloudiness in the water. In another aspect, the invention is directed to methods for making the composition described above. The composition may be used to provide clear beverages that are fortified in calcium and phosphate.

### BACKGROUND

Calcium is an essential element in the human diet. Calcium plays a structural role as one of the components of bones and teeth. It is also an essential element in several physiological systems, such as blood clotting, controlling cell membrane permeability and in muscular contraction, among others. Because calcium is constantly being excreted, and the body cannot synthesize calcium, a human must consume sufficient dietary calcium to provide the body's daily requirement for calcium.

The ability of humans to absorb and to use dietary calcium varies considerably and is a strong function of the other components of the diet. For example, if an individual ingests a high protein meal, typically around 15% of the calcium present in the food is absorbed by the body. On the other hand, when the diet is very low in protein, only about 5% of the dietary calcium is absorbed. Other factors in the diet can have similar effects. Phosphate metabolism is closely linked with calcium metabolism, and the concentration of one affects the absorption of the other. If either calcium or phosphate is present in the body in excess, as the body excretes the excess element, the excretion of the other is also increased.

Phosphorus is found in every cell in the body, but the majority of phosphorus is found associated with calcium in the bones and the teeth. Approximately 10% of the phosphorus in the body, in the form of phosphate, is present in combination with proteins, lipids carbohydrates and with nucleic acids in DNA. Another 10% of the phosphorus in the body is widely distributed in a large variety of compounds throughout the body.

Healthy bones require both calcium and phosphate. The mineral portion of bone is composed of a calcium phosphate known as hydroxyapatite. Healthy bone is constantly being reformed through a process of dissolution and recrystallization of the hydroxyapatite. To operate properly, this process requires a constant source of calcium and phosphate.

It is clear that the ability of food manufacturers to make stable, attractive, low cost products fortified with both calcium and phosphorus, particularly phosphate, could contribute to providing the calcium and phosphorus required for human nutrition. Indeed, food manufacturers desire to fortify their products with calcium phosphates. However, due to the nature of existing calcium phosphates, adding calcium or phosphorus can affect the taste, appearance and other organoleptic properties of the food product.

Calcium phosphate fortification of beverages, in particular clear beverages, has not been common due to cloudiness (turbidity) and other effects caused by the addition of poorly soluble, or insoluble, calcium phosphates to beverages. Use of existing calcium phosphates in beverages has been restricted to turbid beverages, such as orange juice or tomato juice, where the cloudiness or turbidity caused by the addition of calcium phosphate does not significantly effect the appearance of the beverage. Even with turbid beverages, the addition of a calcium phosphate such as a hydroxyapatite can effect the properties of the beverage. For example, hydroxyapatites may absorb color bodies, leading, in the case of tomato juice, to inhomogeneities and shifts in color. In fact, in some instances where cloudiness is desired, calcium phosphates are used as clouding agents in addition to its function as a flow aid. This is the case in certain dry powder mixes where the naturally occurring beverage is turbid (i.e. flavored drinks that contain small to no fruit juice concentrates). For clear beverages, existing calcium phosphates cannot be used as they cause the beverage to be turbid.

Monocalcium phosphate monohydrate or Ca(H₂PO₄)₂—H₂O (“MCP-1”) is poorly soluble in water. As indicated, for example, in U.S. Pat. No. 4,871,554, Table VI, MCP-1 yields cloudy solutions in water. This is because MCP-1 is thermodynamically unstable with respect to dicalcium phosphate and it decomposes to an extent controlled by the acidity to dicalcium phosphate. Dicalcium phosphate is insoluble and gives rise to the cloudiness observed.

Dicalcium phosphate or CaHPO₄ is essentially insoluble in water. The Ksp is 1.83×10⁻⁷ at 25° C. (ref: J. C. Elliott; “The Structure and Chemistry of the Apatites and Other Calcium Orthophosphates”; p. 6 (1994) Elsevier). The material commercially known as tricalcium phosphate, Ca₁₀(PO₄)₆(OH)₂, more properly known as hydroxyapatite, is insoluble in water. The Ksp is 6.62×10⁻¹²⁶. (ref: J. C. Elliott; “The Structure and Chemistry of the Apatites and Other Calcium Orthophosphates”; p. 6 (1994) Elsevier). When tricalcium phosphate is referred to herein, it is understood to be a material which exhibits the x-ray powder pattern of hydroxyapatite.

Reference can also be made to WO98/32344, Table 2, which shows the solubility of calcium phosphates as a function of pH. This table shows that the three known calcium phosphates are all insoluble at pH levels down to 3.5.

To overcome the problem of appearance in calcium fortified beverages, some manufacturers use calcium salts of organic acids alone or in combination with other calcium salts. However, these are costly and can contribute undesirably to the flavor profile of the beverage.

Prior compositions used to provide calcium fortification of beverages have various drawbacks or disadvantages. For example, U.S. Pat. No. 4,851,243 describes the use of calcium phosphate for calcium fortification of milk based products. In this application, the requirement for clarity of the beverage is not important. However, in order to suspend the insoluble calcium phosphate in the milk beverage, the addition of hydrocolloids, such as carrageen and guars, is required.

U.S. Pat. No. 4,871,554 describes the use of a tricalcium phosphate-calcium lactate blend in the proportions 75%/25% (by weight relative to the total calcium from the salts). The patent describes the blend being dispersed in water to partially dissolve the calcium salts, and then adding a citrus containing juice to affect the dissolution of the remaining calcium salts. The object of this patent is calcium fortification of orange and other citrus juices which are not clear. Furthermore, the claimed calcium supplement is shown to increase the pH of the control juice from 3.80 to 4.28. While the patent claims that this change in pH does not have an impact on the flavor profile of the beverage, in other juices a change of this magnitude can be noticeable.

A mixture of calcium hydroxide and organic acids for the preparation of a dry powdered beverage mix is described in U.S. Pat. No. 6,833,146. This patent states that the mixture disperses and dissolves to a large extent upon addition to water. The patent further states that the calcium hydroxide must be chosen correctly so that it will rapidly react with the organic acids to yield a beverage which does not contain too much sedimentation of the calcium salts formed. The beverages described in this reference are not clear and are not based upon the use of pure fruit juices.

U.S. Pat. No. 3,968,263 describes the addition of tricalcium phosphate to dry beverages to provide a calcium phosphate within the beverage to arrest the de-mineralization and/or to aid in the re-mineralization of teeth in low pH beverages. The patent states that the addition of TCP and a suitable acidulant can lead to a cloudy suspension in the beverage. This is undesirable in nominally clear fruit juices. The addition of TCP to an acidic beverage with a pH value of 2.8 to 3.3 as described in the patent is known to those skilled in the art to lead to a cloudy appearance, which is undesirable.

Publication number WO 98/32344 describes the use of calcium glycerophosphate as a calcium source. Calcium glycerophosphate is highly soluble in water. It has a relatively high calcium concentration of about 19% m/m on a dry basis. However, calcium glycerophosphate raises the pH of an aqueous liquid or beverage, and an acid must be added to reduce the pH back to acceptable levels. Thus, the alkalinity of calcium glycerophosphate requires the addition of a second ingredient which adds to the cost of the calcium fortified beverage.

U.S. Pat. No. 6,242,020 describes formulation of a calcium complex for the fortification of beverages, especially targeted at milk. The formulation described is based on a calcium source in combination with a negatively charged emulsifier. The formulation may also include an organic or inorganic acid. The patent states that the calcium complex can be used in fortifying milk without coagulation of the proteins and without changing the texture of the beverage. The calcium complex is prepared in the beverage itself or separately. The emulsifying agent is added to aid in the suspension of the calcium complex. Because milk is an opaque beverage, the complex would not cause cloudiness of the milk, but it is clear that at the pH level of milk, calcium phosphates would not be soluble.

International application no. PCT/US2004/022655 (publication no. WO2005/06882) describes tricalcium phosphate compositions dissolved in acid solutions, which are then used to supplement beverages with calcium. As described in this application, the calcium value in tricalcium phosphate is rendered soluble by dissolution in solutions of acids like citric, malic, fumaric and phosphoric acid. Once the TCP is dissolved in the acid solution, the solution can then be added to a beverage for calcium fortification. This two step process involves the use of organic acids which can add a distinctive flavour to a beverage. Furthermore, the addition of a solution which on a mass basis is composed mainly of water can have a dilutive effect on the beverage and thus the intensity of flavour.

United States Patent Publication No. 2006/0246200 describes a composition of glycine phosphate and glycine citrate with calcium carbonate to produce an effervescent solution containing calcium and phosphate ions in solution. The application explains that after the formed calcium phosphate is solubilized, and addition of flavours, sweeteners etc, a clear beverage is produced. The soluble composition requires citrate ions in solution to maintain the solubility of the calcium ions. The use of glycine phosphate and glycine citrate adds substantial cost to the beverage and in some instances the added organic salts can change the flavour profile of the beverage.

U.S. Pat. No. 2,332,735 describes the addition of organic acids such as tartaric, citric, malic acids to monocalcium phosphate for use in beverage applications. The addition of the organic acids allows for the MCP-1 to be completely soluble in the beverage. This patent highlights the need to add a chelating acid to completely solubilize the calcium phosphate and prevent the formation of a dicalcium phosphate. The organic acids are expensive and can change the flavour profile of a beverage.

U.S. Pat. No. 1,851,210 describes the extraction of triple super phosphate fertilizer with water to form a solution rich in phosphoric acid and dissolved calcium, taking the insoluble portion and extracting yet again with water and treating the second extract with lime to produce DCP, and then treating the DCP with the first extract whereby the free phosphoric acid of the first extract is converted to MCP-1. This document teaches that DCP treated with phosphoric acid can produce MCP-1 for use as a high assay fertilizer.

U.S. Pat. No. 2,514,973 describes the addition of phosphoric acid to monocalcium phosphate to increase its solubility in water. The addition of phosphoric acid to MCP results in a granular product which contains excess phosphoric acid. The patent speaks of the product containing 15-18% free phosphoric acid. This excess phosphoric acid reduces the pH of a solution of the product to very low levels. In an experimental reproduction of the product, the pH of a 1% solution of the product gave a pH value of 2.7. In a beverage application, the use of this product would require the addition of an alkaline ingredient to bring the pH up to acceptable levels for a beverage. This adds unacceptably to the cost of the beverage.

In a similar product, described in U.S. Pat. No. 4,454,103, an MCP-1 product with excess phosphoric acid is prepared by partially neutralizing phosphoric acid with calcium oxide until 95-99% of the phosphoric acid is neutralized. The product from this neutralization reaction is then hydrated with water and then the excess water removed by heating. The process described in this patent requires many steps to yield the final monocalcium phosphate with excess phosphoric acid. In addition, the use of calcium oxide can easily lead to insoluble material in the final product since lime free of acid insoluble material (usually silica) is not available at acceptable prices. Thus, the use of calcium oxide generally leads to material with unacceptably high levels of insoluble material when used to fortify beverages with calcium. Furthermore, the addition of such an excess of phosphoric acid adds unacceptably to the cost. The product is claimed to be useful in effervescent dry beverages as a source of acidity. No examples are offered and the patent is silent on its use in clear beverages.

United States Patent Publication Nos. 2007/0003671 and 2007/0003672 describe the use of mixtures of monocalcium phosphate, tricalcium phosphate and calcium lactate or dicalcium phosphate and calcium lactate. It is evident to one skilled in the art that these calcium phosphates would be insoluble in beverages. This is not detrimental to these applications since they are directed toward calcium fortification of orange juice, a beverage which is, by its nature, turbid.

The pH of most beverages falls in the range of approximately 2 to 7. Fruit juices have a range of pH values in the range of approximately 3 to 4. Fortification of a beverage should not affect the pH or flavour. Indeed, the flavour profile of a beverage is strongly dependent on the pH and acidity of the beverage. Thus, a useful fortifying agent will not alter the pH, otherwise acids must be added to bring the pH values back to optimum ranges. The added complexity and cost as well as the effect of these other added ingredients are undesirable.

A need exists for a solid composition for supplementation of calcium and phosphate in beverages, particularly clear beverages, which is inexpensive, leads to a clear, stable beverage, which does not impact the flavour profile of the beverage and which is easy to handle and to use.

### SUMMARY OF INVENTION

In one aspect, the present invention relates to a composition comprising calcium and phosphorous that is readily soluble in water without any observable cloudiness. X-ray diffraction of the composition indicates that monocalcium phosphate monohydrate and/or monocalcium phosphate anhydrous are the only crystalline compounds present in the composition. Other non-crystalline compounds may also be present in the composition. The composition can be made by combining any one of dicalcium phosphate or tricalcium phosphate with phosphoric acid and mixing the combined materials for a sufficient time to allow them to react. The calcium phosphate may be in an anhydrous or hydrated form. Alternatively, the composition can be made by first combining two or more of monocalcium phosphate, dicalcium phosphate and tricalcium phosphate to form a blend, and then combining the blend of calcium phosphates with phosphoric acid and mixing the combined materials for a sufficient time to allow them to react. The resulting material is a free flowing solid that is readily soluble in water with no observable cloudiness.

The present invention also relates to methods for fortifying beverages with calcium and/or phosphorous by dissolving the composition in the beverage.

### DESCRIPTION OF PREFERRED EMBODIMENTS

The present invention relates to a composition comprising calcium and phosphorus that is readily soluble in water without any observable cloudiness. The composition is a free flowing solid which can be used as a calcium or phosphorus supplementation material. When used as a calcium supplementation material in beverages, the composition does not significantly alter the flavor, pH or color of the beverage.

The composition may be produced by combining any one of dicalcium phosphate or tricalcium phosphate with phosphoric acid and mixing the materials for a sufficient period of time to allow the materials to react. The calcium phosphates may be in a hydrated or anhydrous form. Alternatively, combinations of monocalcium, dicalcium and/or tricalcium phosphate may be combined with phosphoric acid and mixed for a sufficient time to allow the materials to react.

In one embodiment of the invention, dicalcium phosphate is combined with phosphoric acid to produce the composition. In a preferred embodiment, anhydrous dicalcium phosphate is provided and phosphoric acid is added to the dicalcium phosphate over a period of time while mixing. Preferably, 85% phosphoric acid is added to the dicalcium phosphate. The materials may be mixed using conventional mixing equipment. The proportion of dicalcium phosphate to phosphoric acid combined in the final mixture is preferably between about 47.5:52.5 to 56.0:44.0. The 85% phosphoric acid may be added to the dicalcium phosphate at an approximately constant rate over a sufficient period of time to allow complete mixing, preferably between about 30 minutes and 2 hours. After all of the phosphoric acid is added, the mixing may be continued for a period of time, preferably between about 30 minutes and 2 hours. The materials may be combined at ambient temperatures, although the process will produce heat and may cause the temperature of the combined materials to rise.

In another embodiment of the invention, hydrated dicalcium phosphate is combined with phosphoric acid to produce the composition. In a preferred embodiment, dicalcium phosphate duohydrate (CaHPO₄—2H₂O) is provided and phosphoric acid is added to the dicalcium phosphate duohydrate over a period of time while mixing. Preferably, 85% phosphoric acid is added to the dicalcium phosphate duohydrate. The materials may be mixed using conventional mixing equipment. The proportion of dicalcium phosphate duohydrate to phosphoric acid combined in the final mixture is preferably between about 47.5:52.5 to 56.0:44.0. The 85% phosphoric acid may be added to the dicalcium phosphate duohydrate at an approximately constant rate over a sufficient period of time to allow complete mixing, preferably between about 30 minutes and 2 hours. After all of the phosphoric acid is added, the mixing may be continued for a period of time, preferably between about 30 minutes and 2 hours. The materials may be combined at ambient temperatures, although the process will produce heat and may cause the temperature of the combined materials to rise.

In another embodiment of the invention, tricalcium phosphate is combined with phosphoric acid to produce the composition. In this embodiment, tricalcium phosphate is provided and phosphoric acid is added to the tricalcium phosphate over a period of time while mixing. In a preferred embodiment, 85% phosphoric acid is added to the tricalcium phosphate. The materials may be mixed using conventional mixing equipment. The proportion of tricalcium phosphate to phosphoric acid combined in the final mixture is preferably between about 38:62 to 42:58. The 85% phosphoric acid may be added to the tricalcium phosphate at an approximately constant rate over a sufficient period of time to allow complete mixing, preferably between about 30 minutes and 2 hours. After all of the phosphoric acid is added, the mixing may be continued for a period of time, preferably between about 30 minutes and 2 hours. The materials may be combined at ambient temperatures, although the process will produce heat and cause the temperature of the combined materials to rise.

If desired, a portion of the dicalcium phosphate or tricalcium phosphate may be predissolved in the phosphoric acid. This will neutralize some of the acidity of the acid and may result in the need to add an additional quantity, although the amount of acid added on a 100% phosphoric acid basis will be the same.

Where the phosphoric acid added to the dicalcium phosphate or tricalcium phosphate is less than 85% concentration, it may be necessary to add a drying step to the process to obtain solid material that flows well. In this case, the final product is preferably dried so that the weight loss at 100° C. is less than 1%.

In yet another embodiment of the invention, a mixture of dicalcium phosphate and tricalcium phosphate is combined with phosphoric acid to produce the composition. In a preferred embodiment, a blend of anhydrous dicalcium phosphate and tricalcium phosphate is provided and phosphoric acid is added to the dicalcium phosphate/tricalcium phosphate blend over a period of time while mixing. The dicalcium phosphate and tricalcium phosphate may be provided in any proportion of the two phosphates in the blend. In a preferred embodiment, 85% phosphoric acid is added to the dicalcium phosphate/tricalcium phosphate blend. The phosphoric acid and the dicalcium phosphate/tricalcium phosphate blend may be mixed using conventional mixing equipment. The proportion of dicalcium phosphate/tricalcium phosphate to phosphoric acid combined in the final mixture is preferably between about 38:62 to 42:58. The 85% phosphoric acid may be added to the dicalcium phosphate/tricalcium phosphate blend at an approximately constant rate over a sufficient period of time to allow complete mixing, preferably between about 30 minutes and 2 hours. After all of the phosphoric acid may be added, the mixing is continued for a period of time, preferably between about 30 minutes and 2 hours. The materials may be combined at ambient temperatures, although the process will produce heat and cause the temperature of the combined materials to rise.

In yet another embodiment of the invention, a monocalcium phosphate is combined with phosphoric acid to produce the composition. Monocalcium phosphate is provided and phosphoric acid is added to the monocalcium phosphate over a period of time while mixing. In a preferred embodiment, 85% phosphoric acid is added to the monocalcium phosphate. The phosphoric acid and the monocalcium phosphate may be mixed using conventional mixing equipment. The proportion of monocalcium phosphate to phosphoric acid combined in the final mixture is preferably between about 43:57 to 47:53. The 85% phosphoric acid may be added to the monocalcium phosphate at an approximately constant rate over a sufficient period of time to allow complete mixing, preferably between about 30 minutes and 2 hours. After all of the phosphoric acid is added, the mixing may be continued for a period of time, preferably between about 30 minutes and 2 hours. The materials may be combined at ambient temperatures, although the process will produce heat and cause the temperature of the combined materials to rise.

It should be noted that the invention is not limited to a process whereby phosphoric acid is added to a calcium phosphate. In all of the embodiments of the invention described herein, the process can be performed by first providing phosphoric acid and then adding monocalcium phosphate, dicalcium phosphate, tricalcium phosphate or a blend of some or all of the above phosphate products to the phosphoric acid and mixing.

Although the product made by the process described above is a free flowing solid, the flowability of the material can be improved if desired by mixing the final composition with tricalcium phosphate as a final step in the process. For example, dicalcium phosphate and phosphoric acid can be combined as described above to produce the composition of the invention. After the composition has been produced, tricalcium phosphate can be mixed with the composition as a flow aid. The tricalcium phosphate can be added in any amount required to give the final product the desired flow characteristics. In a preferred embodiment, the composition produced by the process is mixed with tricalcium phosphate in the proportion of 95/5 weight to weight.

The inventors unexpectedly discovered that the addition of phosphoric acid to an insoluble calcium phosphate yields a material which is readily soluble in water and clear fruit beverages without residual cloudiness. Upon analysis of the material by X-ray diffraction, it was found to be composed, at least in part, of crystalline mono-calcium phosphate. Although not desiring to be bound to any particular theory or mechanism, the material may contain at least one amorphous component because mono-calcium phosphate does not have the high solubility of the material produced in the manner described above. The amorphous material may be a hemicalcium phosphate type of material. The amorphous material may also be a solution of calcium phosphate dissolved in phosphoric acid. Hemicalcium phosphate is not a known compound, but its sodium congener is known. Hemi-sodium phosphate is a crystalline material. Mono-sodium phosphate forms a hydrate, MSP-1 (NaH₂PO₄—H₂O). Conceptually, one can replace the hydrate by a molecule of phosphoric acid to form NaH₂PO₄—H₃PO₄. By analogy, monocalcium phosphate mono-hydrate could be the basis of a hemicalcium phosphate: monocalcium phosphate mono-hydrate is Ca(H₂PO₄)₂—H₂O and hemi-calcium phosphate would be Ca(H₂PO₄)₂—H₃PO₄.

In addition to the crystalline structure identified by X-ray diffraction, the material produced by the method described above exhibits the following characteristics: (1) it is a free flowing solid; (2) the material dissolves readily in water to yield essentially clear solutions; (3) when used in beverages or juices, the material does not substantially alter the flavor, pH or color of the beverage; (4) when used in beverages or juices the product is stable over time in storage either at refrigerated or ambient temperatures; (5) it is expected that when used in beverages or juices the material remains soluble and does not become turbid after high temperature (UHT) processing.

As discussed above, the material produced by the methods of the present invention can be dissolved in water or beverages to provide an essentially clear solution. The appearance of a beverage, whether clear or cloudy or somewhere in-between, is a subjective measure of clarity. The appearance is dependent on the volume through which light passes before entering the eye, the background against which the sample is viewed, and the concentration of the material in water. As well, while the human eye can state whether or not one sample next to another is cloudier or more turbid than its neighbour, comparing samples is fraught with difficulty. A quantitative method of measuring turbidity relies on the fact that the appearance of turbidity is due to the amount of light which is scattered by suspended particles. Measurements made with a turbidity meter measures the amount of scattered light, by measuring the amount of light at a detector which is placed at an angle (90 degrees) to the incident beam passing through the sample. The apparatus can be calibrated with purchased standards to allow measurements which are accurate and precise. The calibration standards allow one to report turbidity in Nephelometric Turbidity Units (NTU). The material produced in this case preferably can be dissolved in water to produce a 1% solution with a turbidity of less than 5 NTU. The pH of the 1% solution is preferably between 2.8 and 3.2.

Examples of preferred embodiments are provided below. These exemplary embodiments are not intended to limit the methods of the present invention or the resulting compositions in any way.

### EXAMPLE 1

In a Hobart mixer, 200 g of dicalcium phosphate anhydrous is provided at a starting temperature of 20° C. While mixing, 200 g of 85% phosphoric acid at 20° C. was added over a period of one hour. After all of the phosphoric acid was added, the materials were mixed for a further 30 minutes. The product remained a free flowing solid. Some heat was released during the reaction which raised the temperature of the final product to about 40° C. X-ray diffraction on the powder showed the material to contain MCP-1 (mono-calcium phosphate) as the only crystalline compound. When this material was added to water it dissolved completely without any cloudiness and a turbidity of less than 5 NTU.

### EXAMPLE 2

In a Hobart mixer, 160 g of tricalcium phosphate (TCP) is provided at a starting temperature of 20° C. While mixing, 240 g of 85% phosphoric acid at 20° C. was added over a period of one hour. After all of the phosphoric acid was added, the materials were mixed for a further 30 minutes. The product remained a free flowing solid. Some heat was released during the reaction which raised the temperature to about 50° C. X-ray diffraction on the powder showed the material to contain MCP-1 as the only crystalline compound. When this material was added to water it dissolved completely without any cloudiness and a turbidity of less than 5 NTU.

### Non-Working Example 1

To a Littleford-Day plow mixer was added 8.444 kg of MCP-1 (Reagent 12XX as produced by Innophos) which was shown to be pure by X-ray diffraction. 1.339 kg of 85% phosphoric acid at room temperature was sprayed onto the moving bed of room temperature solid over a period of about 30 minutes. The resulting product was dry and free-flowing. A 1% solution of this product had a pH value of 3.08 and a turbidity value of 50. The solution was cloudy

### Non-Working Example 2

To a Littleford-Day plow mixer, Model was 8.444 kg of MCP-1 (Regent 12XX as produced by Innophos) which was shown to be pure by X-ray diffraction. 1.621 kg of 85% phosphoric acid at room temperature was sprayed on the moving, room temperature bed in the plow mixer while mixing at medium speed over a period of about 30 minutes. The resulting product was dry and free-flowing. A 1% solution of this product had a pH value of 2.9 and a turbidity value of 11. The solution was cloudy.

The examples and non-working examples are collected together in the following table to illustrate their differences. One can see that a 48% mole excess of phosphoric acid is required to generate sufficient acidity to dissolve MCP-1 as described in U.S. Pat. No. 2,519,473 and generate a clear solution. A material with a pH of 2.7 is not of food grade specifications, and furthermore, the calcium concentration would not be practical. In spite of the alkalinity of TCP, operating in accordance with the present invention allows one to produce a material with acceptable calcium loading and pH and which also dissolves completely in water without any trace of cloudiness.

| | Calcium Source | | | | | |
|---|---|---|---|---|---|---|
| | DCP-0 | TCP | MCP-1 | MCP-1 | MCP-1 | CaO |
| | Reference | | | | | |
| | | | Non- | Non- | | |
| | Example | Example | working | working | | |
| | 1 | 2 | example | example | U.S. Pat. No. 2519473 | U.S. Pat. No. 4454103 |
| Mass (g) | 200 | 160 | 8444 | 8444 | 45400 | 1050 |
| Mass of | 200 | 240 | 1339 | 1621 | 16344 | 4847 |
| 85% (or | | | | | | |
| equivalent) | | | | | | |
| (g) | | | | | | |
| Excess | 18 | 31 | 34 | 42 | 48 | 24 |
| moles | | | | | | |
| acid/Moles | | | | | | |
| of MCP (%) | | | | | | |
| pH | 3 | 3 | 3.08 | 2.9 | 2.7 | 11.5 |
| NTU | <5 | <5 | 50 | 11 | <5 | >200 |

The composition produced by the processes of the present invention may be used to calcium fortify beverages, in particular clear beverages and juices. Because the material is readily soluble, beverages can be calcium fortified to any desired level by adding sufficient material to provide the calcium necessary to achieve the desired level. The material can similarly be used to provide dietary phosphorous by adding sufficient material to achieve a desired phosphorus concentration in the beverage.

While preferred embodiments have been shown and described, various modifications and substitutions may be made without departing from the spirit and scope of the invention. Accordingly, it is to be understood that the present invention has been described by way of example and not by limitation.

We claim:

1. A process for producing a composition which may be used to calcium fortify beverages or juices, comprising the step of:
combining a calcium phosphate selected from the group consisting of anhydrous dicalcium phosphate, calcium phosphate duohydrate, tricalcium phosphate, and combinations thereof with phosphoric acid while mixing, wherein the proportion of calcium phosphate to phosphoric acid in the final mixture is such that a 1 wt % solution of the resulting product has a turbidity of less than 5 NTU and a pH of between about 2.8 to 3.2.

2. The process of claim 1, further comprising the step of drying the final product until the product has a weight loss at 100° C. of less than 1%.

3. The process of claim 1, wherein the phosphoric acid is 85% phosphoric acid.

4. The process of claim 3, wherein the calcium phosphate and phosphoric acid are mixed for a period of between about 30 minutes and 2 hours.

5. The process of claim 1, further comprising the step of adding a quantity of trisodium phosphate to the final mixture of a calcium phosphate and phosphoric acid.

6. The process of claim 5, wherein the proportion of the final mixture of a calcium phosphate and phosphoric acid to trisodium phosphate is about 95:5.

7. The process of claim 1, wherein the phosphoric acid contains a quantity of a calcium phosphate selected from the group consisting of anhydrous dicalcium phosphate, calcium phosphate duohydrate, tricalcium phosphate, and combinations thereof dissolved in the phosphoric acid prior to combining the phosphoric acid with the calcium phosphate.

8. The process of claim 1, wherein the calcium phosphate is anhydrous dicalcium phosphate and the proportion of anhydrous dicalcium phosphate to phosphoric acid in the final mixture is between about 47.5:52.5 to 56.0:44.0.

9. The process of claim 8, wherein the phosphoric acid is 85% phosphoric acid.

10. The process of claim 1, wherein the calcium phosphate is anhydrous dicalcium phosphate duohydrate and the proportion of dicalcium phosphate duohydrate to phosphoric acid in the final mixture is between about 47.5:52.5 to 56.0:44.0.

11. The process of claim 10, wherein the phosphoric acid is 85% phosphoric acid.

12. The process of claim 1, wherein the calcium phosphate is tricalcium phosphate and the proportion of tricalcium phosphate to phosphoric acid in the final mixture is between about 38:62 to 42:58.

13. The process of claim 12, wherein the phosphoric acid is 85% phosphoric acid.

14. The process of claim 1, wherein the calcium phosphate is a blend of anhydrous dicalcium phosphate and tricalcium phosphate and the proportion of the anhydrous dicalcium phosphate and tricalcium phosphate blend to phosphoric acid in the final mixture is between about 38:62 to 42:58.

15. The process of claim 14, wherein the phosphoric acid is 85% phosphoric acid.

16. The product produced by the process of any one of claims 1 to 15.
